(19) United States
(12) Patent Application Publication
(10) Pub. No.: US 2025/0307580 A1
(43) Pub. Date: Oct. 2, 2025

(54) TOOL IDENTIFIER RECOGNITION AND SENSOR CALIBRATION IN A TOOL CONTROL SYSTEM

(71) Applicant: SNAP-ON INCORPORATED, Kenosha, WI (US)

(72) Inventors: Matthew J. Lipsey, Sherwood, AR (US); David C. Fly, Maumelle, AR (US); Frederick J. Rogers, North Little Rock, AR (US)

(21) Appl. No.: 19/096,095

(22) Filed: Mar. 31, 2025

Related U.S. Application Data
(60) Provisional application No. 63/572,816, filed on Apr. 1, 2024.

(51) Int. Cl. G06K 7/10; G06K 19/06

(52) U.S. Cl. CPC G06K 7/10861; G06K 19/06093; G06K 2019/06225

(57) ABSTRACT

The disclosure comprises systems and methods for identifying color-coded tags on tools in a storage container where the identification sensor can be calibrated and adjusted. The method can include capturing image data comprising a plurality of pixels of an identification tag associated with a tool in a storage container. The method can include correlating a plurality of pixels to a numeric hue value. The method can include identifying a pattern of pixels from the plurality of pixels, wherein the pattern of pixels is correlated to a known pattern of color parameters consistent with the identification tag associated with the tool in the storage container. Further in response to identifying the pattern of pixels is consistent with the identification tag, determining the presence or absence of the tool in the storage container. The method can further include implementing a color gain to adjust a boundary range for a color.

### CROSS REFERENCE TO RELATED APPLICATIONS

This present application claims the benefit of priority under 35 U.S.C. § 119(e) to U.S. Provisional Application No. 63/572,816, filed Apr. 1, 2024, the disclosure of which is hereby incorporated by reference in its entirety for all purposes.

### TECHNICAL FIELD

The present disclosure generally relates to managing tools in a storage container and, more particularly, identification of color-coded tool identifiers in the storage container.

### BACKGROUND

In today's state of the art Automated Tool Control systems, cameras are used to scan a layer of tool control foam with item storage “pockets” and determine if the item is present in the pocket or absent from the pocket. The cameras compare imaging data from the currently scanned image with imaging data from stored reference images and make a presence and absence determination based on current image data similarity to the stored reference data from images where all items are present or where they are absent.

When using color-coded tags to identify tools, the tag printing process can differ from batch to batch resulting in different color/hue values for each tag stripe. Further inconsistent coloring can cause the tag color values to shift higher or lower on the bin spectrum and cause the color/hue to shift into adjacent color/hue bins. As a result, the color/hue could be misidentified as an adjacent color/hue and the code of the tag being evaluated is also misidentified. There exists a need to refine the image data associated with the tools and tagging/identifying the tools.

### BRIEF SUMMARY

The disclosure comprises systems and methods for identifying color-coded tags on tools in a storage container where the identification sensors can be calibrated and adjusted. The method can include capturing image data comprising a plurality of pixels of an identification tag associated with a tool in a storage container. The method includes correlating a plurality of pixels to a numeric hue value. The method includes identifying a pattern of pixels from the plurality of pixels, wherein the pattern of pixels is correlated to a known pattern of color parameters consistent with the identification tag associated with the tool in the storage container. Further in response to identifying the pattern of pixels is consistent with the identification tag, the method includes determining the presence or absence of the tool in the storage container. The method can further include implementing a color gain to adjust a boundary range for a color.

Another aspect of the present disclosure relates to a system configured for identifying color-coded tags on tools in a storage container where the identification sensors can be calibrated and adjusted. The system can include a plurality of storage locations for storing objects. The system can include at least one image sensing device configured to capture image data of the plurality of storage locations; and a data processor configured to execute computer-readable instructions wherein the instructions include: capturing image data comprising a plurality of pixels of an identification tag associated with a tool in a storage container. The instructions include correlating a plurality of pixels to a numeric hue value. The instructions include identifying a pattern of pixels from the plurality of pixels, wherein the pattern of pixels is correlated to a known pattern of color parameters consistent with the identification tag associated with the tool in the storage container. Further in response to identifying the pattern of pixels is consistent with the identification tag, the instructions include determining the presence or absence of the tool in the storage container.

### BRIEF DESCRIPTION OF THE DRAWINGS

The present disclosure is illustrated by way of example, and not by way of limitation, in the accompanying drawings, wherein elements having the same reference numeral designations represent like elements throughout and wherein:

FIGS. 1A and 1B show exemplary storage units in which implementations according to this disclosure may be implemented;

FIG. 2 shows details inside an exemplary storage drawer operated in the open mode;

FIG. 3 shows an exemplary tool storage system according to this disclosure;

FIGS. 4A-4C and 4E are different views of the tool storage system shown in FIG. 3;

FIG. 4D illustrates how an exemplary image is stitched together;

FIG. 5A depicts an exemplary image of a color-coded identifier on a tool;

FIG. 5B is a low-quality image of the color-coded identifier of FIG. 5A for a tool;

FIG. 5C depicts a user interface setting for a calibration display;

FIG. 5D depicts a histogram of bins of color band ranges;

FIGS. 6A-6C illustrate an example of timed image capturing;

FIGS. 7A and 7B are different views of another implementation of camera designs;

FIG. 8 is a block diagram of an exemplary networked inventory control system;

FIGS. 9 and 10 illustrate functional block diagram illustrations of general purpose computer hardware platforms; and

FIG. 11 illustrates an exemplary process for using sensor devices to identify the color-coded identifiers for a tool.

### DETAILED DESCRIPTIONS

In the following description, for the purposes of explanation, numerous specific details are set forth in order to provide a thorough understanding of the present disclosure. Specifically, operations of illustrative implementations that utilize machine vision to identify inventory conditions of a storage unit are described in the context of tool management and tool inventory control. It will be apparent, however, to one skilled in the art, that concepts of the disclosure may be practiced or implemented without these specific details. Similar concepts may be utilized in other types of inventory control systems such as warehouse management, jewelry inventory management, sensitive or controlled substance management, mini bar inventory management, drug management, vault or security box management, etc. In other instances, well-known structures and devices are shown in block diagram form in order to avoid unnecessarily obscuring the present disclosure.

Inventory control systems have reason to track a range of data concerning the contents of the system. Inventory storage locations must be identified and located prior to an issue or return from stock. Certain inventory may have required maintenance procedures that must be performed at a particular date. This maintenance may include calibration, certification, inspection, lubrication, component replacement, complete replacement, diagnostic test, etc. Certain inventory may have a limited effective lifetime and require replacement after a given time period or a given number of uses. During the course of normal operations, certain inventory may be considered to be in an unusable state due to damage, malfunction, corrosion, contamination, etc. Certain inventory is considered consumable and it is desirable to track on-hand quantities to enable on demand replacement. It is desirable to track many aspects of the inventory issue and return process for accountability or efficiency purposes. Due to the large amount of data that can be associated with each item in the inventory control system, it is essential to have efficient means for recording and reporting the data.

According to this disclosure, an inventory control system for monitoring the removal and replacement of objects has at least one drawer or tray including storage locations for storing objects, and at least one image sensing device configured to form an image of the storage locations. The inventory control system also includes a data processor configured to receive information representing the image of the storage locations, and is further configured to apply a visual contrast element to the image to indicate one of the objects is an item of interest.

When tools are used in a manufacturing or service environment, it is important that tools be returned to a storage unit, such as a toolbox, after use. It is also important that full advantage be taken of the electronic capabilities of the system. These capabilities may include means and methods that improve user efficiency, enhance tool security, ensure that users are aware of tool calibration and inspection requirements, and that users are aware of specific tool status changes. Other capabilities disclosed in this disclosure ensure data is transferred between the electronic inventory control system and its administration computer and from the inventory control system's administration computer to the customer's database both securely and efficiently.

Furthermore, if an industry desires to group tools together for specific job requirements or as a kit of similar or identical tools, there may be a need to subdivide the foam layouts with cutouts for specific tools into pallets. The pallets can be issued from the tool storage unit as a whole with all the kitted tools included therein, or individual tools can be issued and returned while the pallet remains in the tool storage device.

The inventory control system of the instant application may also allow for organizing the tool control storage devices into groups depending on their intended target usage and authorization level. Examples of groups for the tool control storage devices may include avionics, tail section, wing section, etc. The tool control storage devices may be typically controlled by the type of tools contained within the toolbox. Examples of working groups for users may be by shift or by work area such as an avionics group or engine group. Users may also be grouped by authorization levels on the box or the administrative application. Authorization levels for users on the tool control tool storage device may be User, Maintenance, and Administrator. Authorization levels for groups on the administrative application may be User, Maintenance, and Administrator, Super user and Super viewer.

Many inventory control systems can operate on their own network independent of any other network system or interface. However, many customers, especially the large aerospace industrial and government users, intend to link the inventory control system and database with their own network and database. This allows for transfer of data between systems. This disclosure describes the use of web services as defined by the WWW consortium (W3C) for use as the data link/interface between the inventory control system and the customer's database system. In addition, this disclosure describes use of web services as defined by the W3C for use as the data link/interface between remote administration application users and the inventory control system and between remote viewers of specific displayed data and the administrative application of the inventory control system.

Since one of the functions of the inventory control systems is to ensure that all tools are accounted for and that no work product leaves the work area with a tool in it when work is concluded, this disclosure describes the ability for the administrative application to lock down the tool storage devices until authorized auditors complete an audit of the contents. The capability to lock down selected tool storage devices may be on a timed basis and/or may be by authorized users. It may be preceded by a requirement to return all tools to the box prior to lock down. The administrator may define authorized auditors for each tool storage device and the number of auditors required to complete an audit on each individual tool storage device.

In the inventory control systems with display capabilities of the tool storage device in the drawer or tray opening and drawer or tray closing configurations, the current capabilities to link the pan and zoom features between the two related images for each drawer or tray cycle do not exist. The images may need to be panned and zoomed individually. It may be desirable to link the pan and zoom features together for both images so the region of interest to the viewer is then displayed to the user at all times. It may also be desirable to allow the user to right click the mouse when in the viewing function and return both images to normal resolution and placement simultaneously.

In another aspect, for automated tool storage devices, when in typical usage, if a kit is included in the tool storage device and the kit is in a container and the kit contains single or multiple components, the users of the storage device may be required to open the kit and verify the contents each time the kit is returned to the tool storage device after being issued. Verification may involve one user or more than one user. In current practice, the users may rely on memory or prior knowledge to verify the contents of the returned kits. Due to human error, reliance on memory or prior knowledge may lead to erroneous verification and a possible lost tool or a tool left in the work product. The inventory control system of the instant application may be configured to display a list of the kit content on the tool storage device screen and to also have the capability to display a photographic image of the kit content on the tool storage device screen. The photographic image may be provided by an imaging equipped automated tool storage device or by a simple photograph downloaded from an external camera.

In many cases, industries publish a written work order to describe the work to be done, the location of the work, a document number for work processes and a document number for the tools to be used in the performance of the job requirements and other possible work-related activities and documents. The work orders may include a bar code or other identifying marks, which is machine readable and for which the machine (computer) can be programmed to store information. The inventory control system of the instant application may be equipped with a device to read the identifying mark (bar code) on the work order and associate it with stored data such as work location and required tool lists. The inventory control system may be capable of displaying the stored data, i.e., work location required tool lists or other stored data associated with the identifying mark on the work order.

Since the inventory control system can be equipped with a touch screen monitor, the system is capable of displaying work locations to be selected by the user. Currently, the inventory control system may require the work location to be chosen after the user has swiped his badge across the systems card reader. By selecting a work location, the user may then be allowed access to the tool storage device based on previously set access rights. The current configuration of the work locations displayed on the touch screen of the inventory control system is a grid with the text of the work location name included inside each individual block. The grid with work locations text may be displayed on multiple pages depending on the number of work locations available. This disclosure describes a method where a visual representation of the work product is displayed on the screen and the work areas are defined as sections of the work product. For example, if the work product is an area, then the graphic representation could be an overhead view of the aircraft. By selecting a section of the aircraft, the user is selecting the work location required to gain access to the tool storage device. The graphical representations of the work product could be broken down to multiple levels as well. For instance, if a user chose the tail section of the aircraft to be worked on, the tail section can be displayed, with its individual work locations, such as rudder, right rear flap, left rear flap, etc.

Some industries, especially in aerospace where government agencies or contractors are interested in higher levels of security, may require multi-factor authentication to gain access to the tool storage device and administrative computer in an automated tool control system. An example of multi-factor authentication used to enhance security is described in this disclosure. For example, a user may be required to scan a badge containing security information which in turn triggers a display to enter a pin number on the tool storage device's touch screen. Once the multi-factor requirements have been satisfied, the user may be allowed access to the automated tool storage device.

Many industries store employee data in an Active Directory, such as name, employee number, badge number, and other identifying data. It may be desirable to have the capability to download certain employee information from the Active Directory for use in the inventory control system. The inventory control system may use this information to identify authorized users and their appropriate access to the tool storage device or administration's computer workstation. The current method of loading employee data into the inventory control system may include adding the user information such as name, employee or badge number, or photograph manually. This disclosure describes a process whereby Active Directory information can be transferred to the inventory control system and used appropriately.

The inventory control system of the instant application may include a touch screen display with scroll bars capability. The scroll bars, however, may be small and may be sometimes difficult to scroll the screen up, down and sideways. To this end, the display of the inventory control system of the instant application may also include touch screen flick and pinch functions for manipulating the display.

With this overview, reference now is made in detail to the examples illustrated in the accompanying drawings and is discussed below.

### Overview of Exemplary Tool Storage Systems

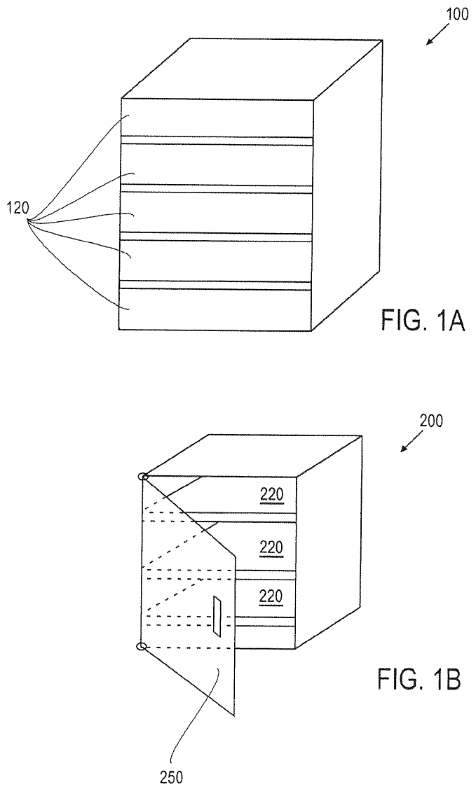

FIGS. 1A and 1B show exemplary storage units in which inventory control systems according to this disclosure may be implemented. FIG. 1A is an exemplary tool storage system 100 including multiple storage drawers 120. Each storage drawer 120 includes multiple storage locations for storing various types of tools. As used throughout this disclosure, a storage location is a location in a storage system for storing or securing objects. In one implementation, each tool has a specific pre-designated storage location in the tool storage system.

Each storage drawer operates between a closed mode, which allows no access to the contents of the drawer, and an open mode, which allows partial or complete access to the contents of the drawer. When a storage drawer moves from a closed mode to an open mode, the storage drawer allows increasing access to its contents. On the other hand, if a storage drawer moves from an open mode to a closed mode, the storage drawer allows decreasing access to its contents. As shown in FIG. 1A, all storage drawers 120 are in closed mode.

A locking device may be used to control access to the contents of the drawers 120. Each individual drawer 120 may have its own lock or multiple storage drawers 120 may share a common locking device. Only authenticated or authorized users are able to access the contents of the drawers.

The storage drawers may have different sizes, shapes, layouts and arrangements. FIG. 1B shows another type of tool storage system 200 which includes multiple storage shelves or compartments 220 and a single door 250 securing access to the storage shelves 250. The storage shelves or compartments may come in different sizes, shapes, layouts and arrangements.

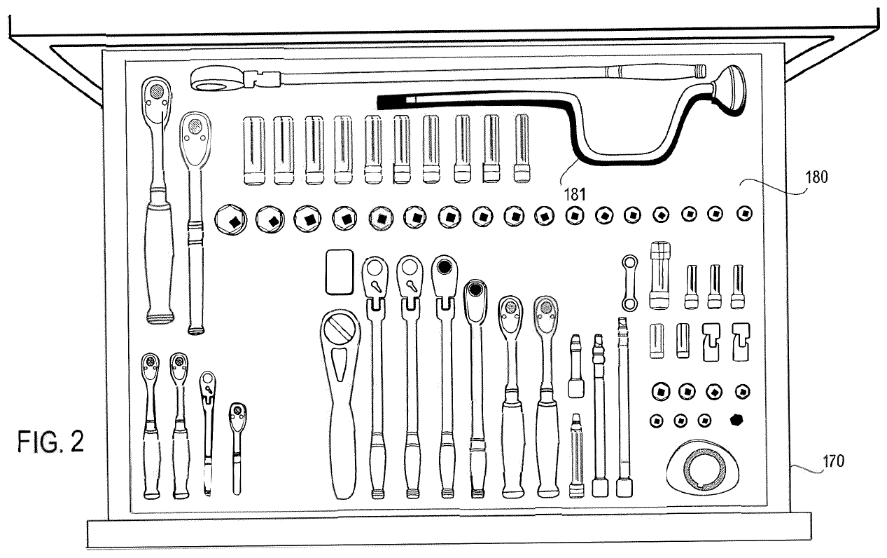

FIG. 2 shows details inside an exemplary storage drawer 170 in the open mode. Each storage drawer 120 includes a foam base 180 having at least one storage location, such as cutouts 181, for storing tools. Each cutout is specifically contoured and shaped for fittingly receiving a tool with corresponding shapes. Tools may be secured in each storage location by using hooks, Velcro, latches, pressures from the foam, etc.

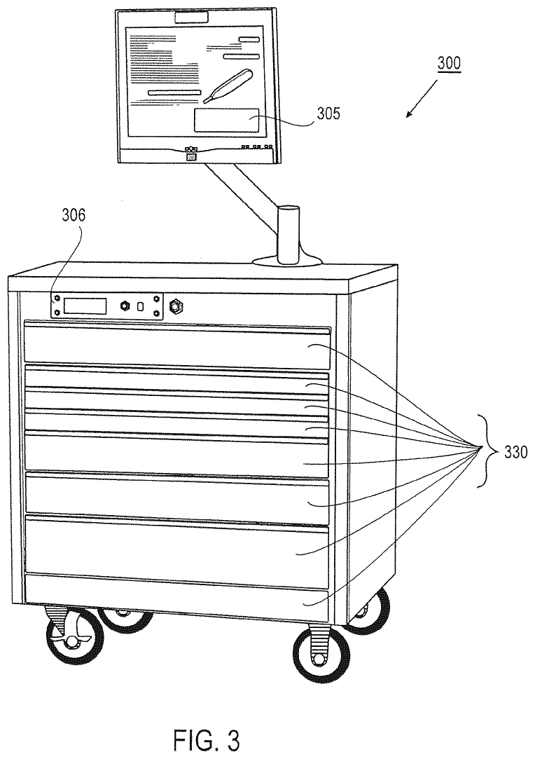

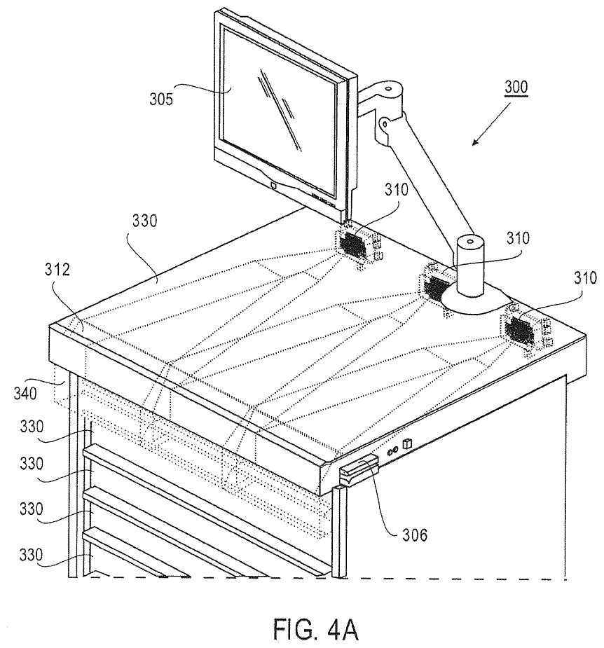

FIG. 3 shows an exemplary inventory control system implemented as a tool storage system 300 according to this disclosure for storing tools. Storage system 300 includes a display 305, an access control device 306, such as a card reader, for verifying identity and authorization levels of a user intending to access storage system 300, and multiple tool storage drawers 330 for storing tools. Tool storage system 300 includes an image sensing device configured to capture images of contents or storage locations of the system. The image sensing device may be lens-based cameras, CCD cameras, CMOS cameras, video cameras, or any type of device that captures images. In a further aspect, the image sensing device can comprise a plurality of sensing devices. For example, the system can comprise both the visible light detecting camera and other types of image sensing devices. Furthermore, both types of images can be used to be a reference for the other. Using multiple types of image sensing devices can provide benefits when the certain environmental factors such as sunlight may impact the image captured.

System 300 includes a data processing system, such as a computer, for processing images captured by the image sensing device. Images captured or formed by the image sensing device are processed by the data processing system for determining an inventory condition of the system or each storage drawer. The term inventory condition as used throughout this disclosure means information relating to an existence or non-existence condition of objects.

The data processing system may be part of tool storage system 300. In one implementation, the data processing system is a remote computer having a data link, such as a wired or wireless link, coupled to tool storage system 300; or a combination of a computer integrated in storage system 300 and a computer remote to storage system 300. Detailed operations for forming images and determining inventory conditions will be discussed shortly.

Drawers 330 are similar to those drawers 120 shown in FIG. 1A. Display 305 is an input and/or output device of storage system 300, configured to output information. Information entry via display 305 is possible such as by using a touch screen display. Access control device 306 is used to limit access to tool storage drawers 330 to authorized users only. Access control device 306, through the use of one or more locking devices, keeps all storage drawers 330 locked in a closed position until access control device 306 authenticates a user's authorization for accessing storage system 300. Access control device 306 may use one or more access authentication means to verify a user's authorization levels, such as by using a keypad to enter an access code, a keycard reader to read from a key card or fobs authorization level of a user holding the card or fob, biometric methods such as fingerprint readers or retinal scans, or other methods. If access control device 306 determines that a user is authorized to access storage system 300, it unlocks some or all storage drawers 330, depending on the user's authorization level, allowing the user to remove or replace tools. In one implementation, access to each storage drawer 330 is controlled and granted independently. Based on an assigned authorization or access level, a user may be granted access to one or more drawers of system 300, but not to other drawers. In one implementation, access control device 306 relocks a storage drawer 330 when or after a user closes the drawer.

The location of access control device 306 is not limited to the front of storage system 300. It could be disposed on the top of the system or on a side surface of the system. In one implementation, access control device 306 is integrated with display 305. User information for authentication purposes may be input through the display device with touch screen functions, face detection cameras, fingerprint readers, retinal scanners or any other types of devices used for verifying a user's authorization to access storage system 300.

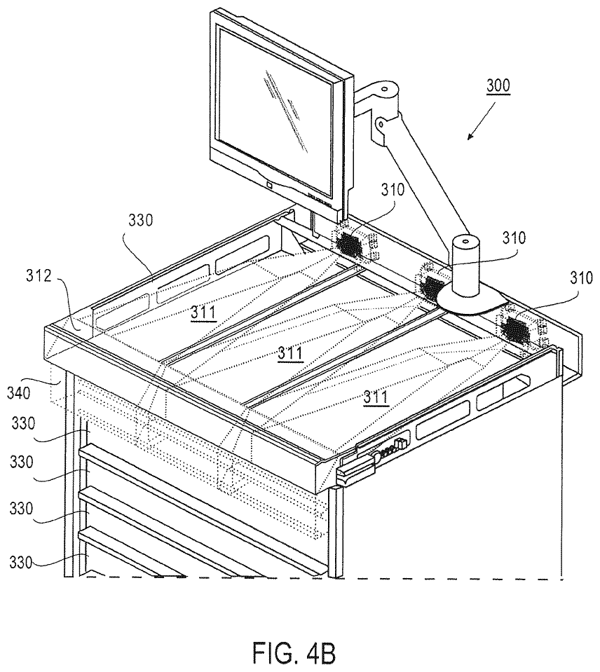

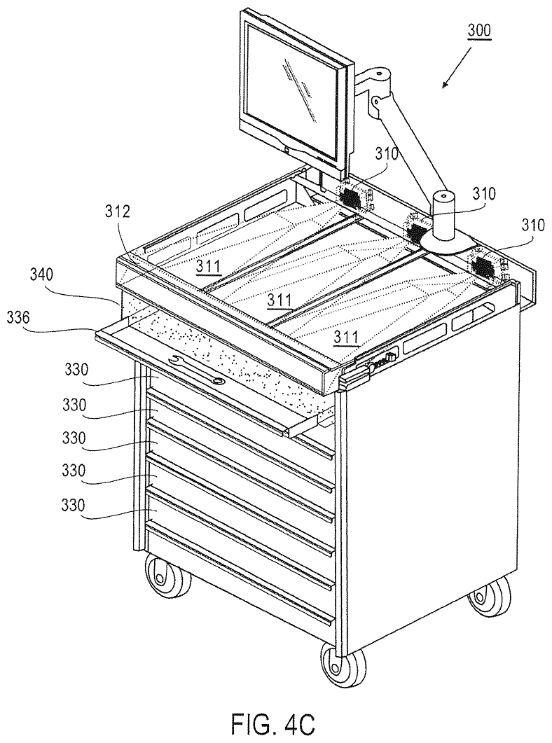

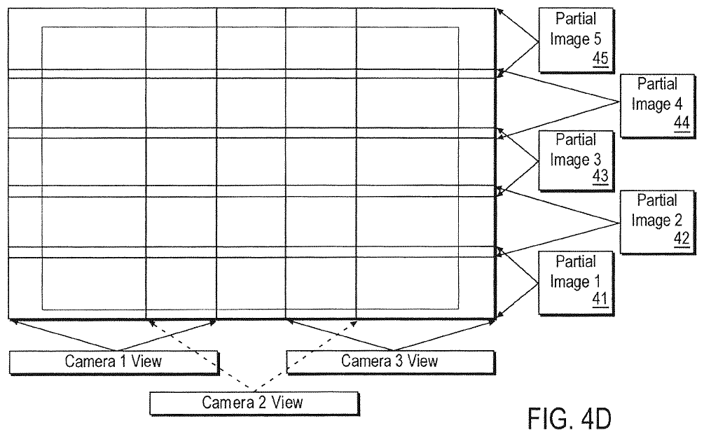

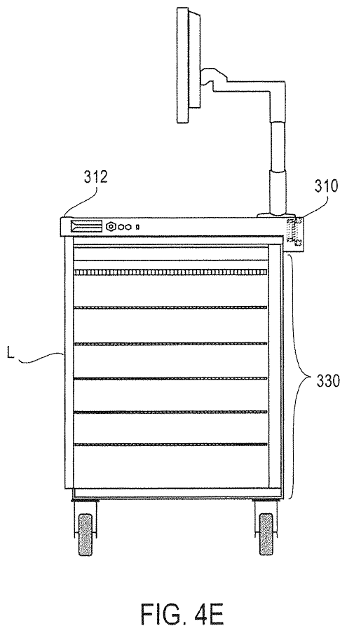

FIGS. 4A and 4B show a partial perspective view of tool storage system 300. As illustrated in FIG. 4A, an access control device 306 in the form of a card reader is disposed on a side surface of the system. Storage system 300 includes an imaging compartment 330 which houses an image sensing device comprising three cameras 310 and a light directing device, such as a mirror 312 having a reflection surface disposed at about 45 degrees downwardly relative to a vertical surface, for directing light reflected from drawers 330 to cameras 310. The directed light, after arriving to cameras 310, allows cameras 310 to form images of drawers 330. The shaded area 340 below mirror 312 represents a viewing field of the image sensing device of tool storage system 300. Mirror 312 has a width equal to or larger than that of each storage drawer, and redirects the camera view downwards toward the drawers. FIG. 4E is an illustrative side view of system 300 showing the relative position between cameras 310, mirror 312 and drawers 330. Light L reflected from any of drawers 330 to mirror 312 is directed to cameras 310.

FIG. 4B is a perspective view identical to FIG. 4A except that a cover of imaging compartment 330 is removed to reveal details of the design. Each camera 310 is associated with a viewing field 311. As shown in FIG. 4B, the combined viewing fields of cameras 310 form the viewing field 340 of the image sensing device. Viewing field 340 has a depth of x. For instance, the depth of viewing field 340 may be approximately 2 inches.

FIG. 4C is an alternative perspective view of tool storage system 300 shown in FIG. 4A, except that a storage drawer 336 now operates in an open mode allowing partial access to its contents or storage locations in storage drawer 336.

This arrangement of cameras 310 and mirror 312 in FIGS. 4A-4C allows cameras 310 the capability of capturing images from the top drawer to the bottom drawer, without the need to substantially change its focal length.

In one implementation, cameras 310 capture multiple partial images of each storage drawer as it is opened or closed. Each image captured by cameras 310 may be associated with a unique ID or a time stamp indicating the time when the image was captured. Acquisition of the images is controlled by a data processor in tool storage system 300. In one implementation, the captured images are the full width of the drawer but only approximately 2 inches in depth. The captured images overlap somewhat in depth and/or in width. As shown in FIG. 4D, the partial images 41-45 taken by different cameras 310 at different points in time may be stitched together to form a single image of a partial or entire drawer and its contents and/or storage locations. This stitching may be performed by the data processor or by an attached or remote computer using off-the-shelf software programs. Since images are captured in approximately two-inch slices, multiple image slices are captured by each camera. One or more visible scales may be included in each drawer. The processor may monitor the portion of the image that contains the scale in a fast-imaging mode similar to video monitoring. When the scale reaches a specified or calculated position, the data processing system controls the image sensing device to capture and record an image slice. The scale may also assist in photo stitching. Additionally, a pattern such as a grid may be applied to the surface of the drawer. The pattern could be used to assist the stitching or image capturing process.

In another implementation, the image sensing device includes larger mirrors and cameras with wide angle lens, in order to create a deeper view field x, such that the need for image stitching can be reduced or entirely eliminated.

In one implementation, one or more line scan cameras are used to implement the image sensing device. A line scan camera captures an image in essentially one dimension. The image will have a significant width depending on the sensor, but the depth is only one pixel. A line scan camera captures an image stripe spanning the width of the tool drawer but only one pixel deep. Every time drawer 330 moves by a predetermined partial amount, the camera will capture another image stripe. In this case, the image stripes must be stitched together to create a usable full drawer image. This is the same process used in many copy machines to capture an image of the document. The document moves across a line scan camera and the multiple image stripes are stitched together to create an image of the entire document.

In addition to a mirror, it is understood that other devices, such as prisms, a combination of different types of lenses including flat, concave, and/or convex, fiber optics, or any devices that may direct light from one point to another may be used to implement the light directing device for directing light coming from an object to a remote camera. Another option could be the use of fiber optics. The use of a light directing device may introduce distortions into the captured images. Calibrations or image processing may be performed to eliminate the distortions. For instance, cameras 310 may first view a known simple grid pattern reflected by the light directing device and create a distortion map for use by the data process processor to adjust the captured image to compensate for mirror distortion.

For better image capture and processing, it may be desirable to calibrate the cameras. The cameras may include certain build variations with respect to image distortion or focal length. The cameras can be calibrated to reduce distortion in a manner similar to how the mirror distortion can be reduced. In fact, the mirror calibration could compensate for both camera and mirror distortion, and it may be the only distortion correction used. Further, each individual camera may be calibrated using a special fixture to determine the actual focal length of their lenses, and software can be used to compensate for the differences from camera to camera in a single system.

In one implementation, the image sensing device does not include any mirror. Rather, one or more cameras are disposed at the location where mirror 312 was disposed. In this case, the cameras point directly down at storage drawers 330 when they move. In another implementation, each storage drawer 330 has one or more associated cameras for capturing images for that storage drawer.

### Determination of Inventory Conditions

System 300 determines the presence or absence of tools in drawers 330 based on captured images using a variety of possible strategies. Suitable software may be executed by the embedded processor or an attached computer (PC) for performing inventory determinations based on captured images.

In one example, system 300 determines an inventory condition of a storage drawer based on empty locations in the drawer. Each storage location in the drawer is configured to store a pre-designated object, such as a pre-designated tool. A non-volatile memory device of system 300 stores information identifying a relationship between each known storage location in the drawer and its corresponding pre-designated object. The memory device also stores information of two baseline images of the drawer: one baseline image having each of its storage locations occupied by the corresponding pre-designated object, and another baseline image having its storage locations unoccupied. In determining an inventory condition of the drawer, the data processor compares an image of the drawer and each of the baseline images. Based on a difference of the images, the data processor determines which storage location in the drawer is not occupied by its corresponding pre-designated object. The identity of the missing object is determined based on the stored relationship identifying each storage location and its corresponding pre-designated object.

Another implementation according to this disclosure utilizes a specially designed identifier for determining an inventory condition of objects. Depending on whether a storage location is being occupied by an object, an associated identifier appears in one of two different manners in an image captured by the image sensing device. For instance, an identifier may appear in a first color when the associated storage location is occupied by a tool and a second color when the associated storage location is unoccupied. The identifiers may be texts, one-dimensional or two-dimensional bar codes, patterns, dots, codes, symbols, figures, numbers, LEDs, lights, flags, etc., or any combinations thereof. The different manners that an identifier may appear in an image captured by the image sensing device include images with different patterns, intensities, forms, shapes, colors, etc. Based on how each identifier appears in a captured image, the data processor determines an inventory condition of the object.

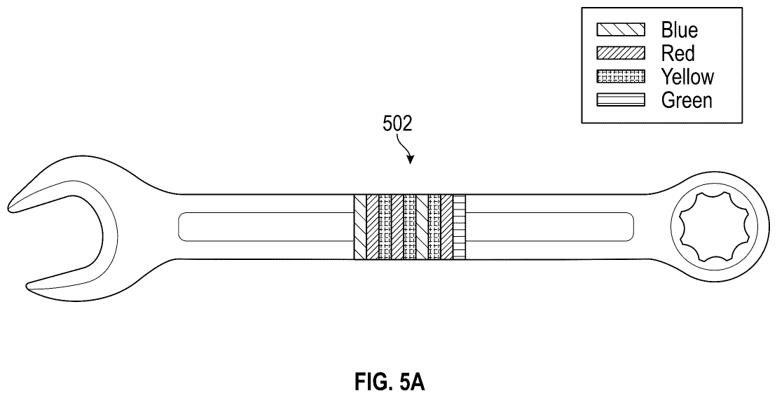

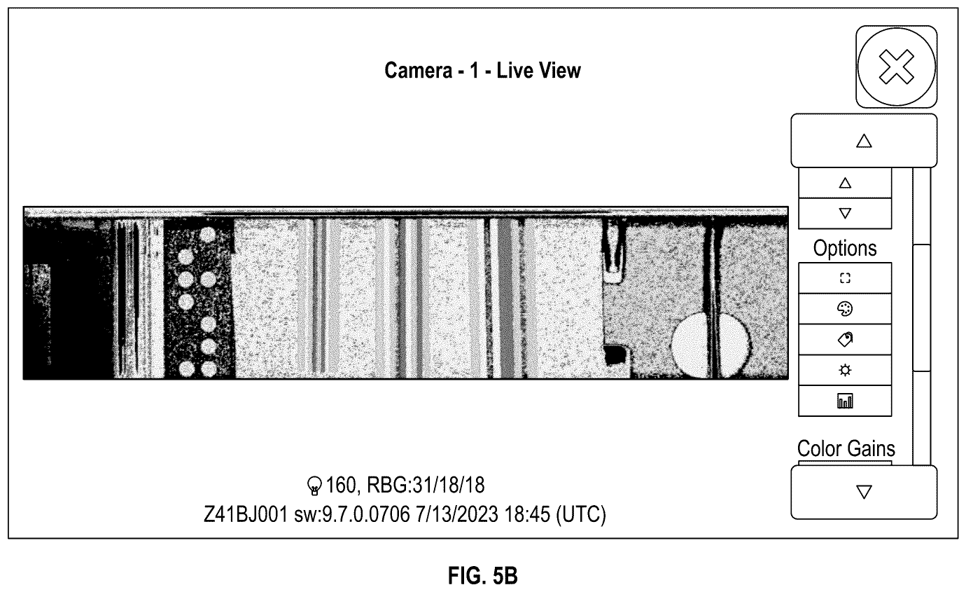

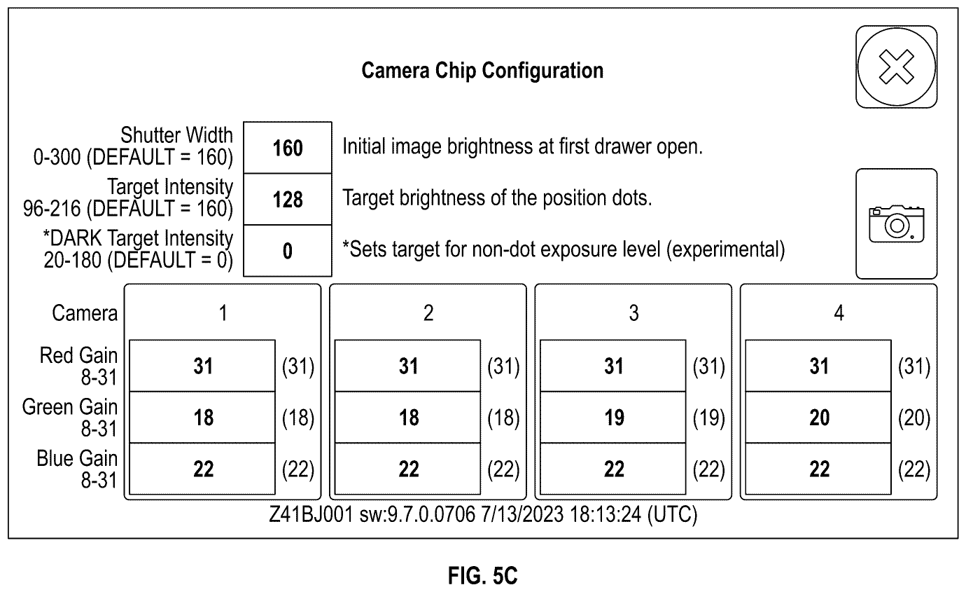

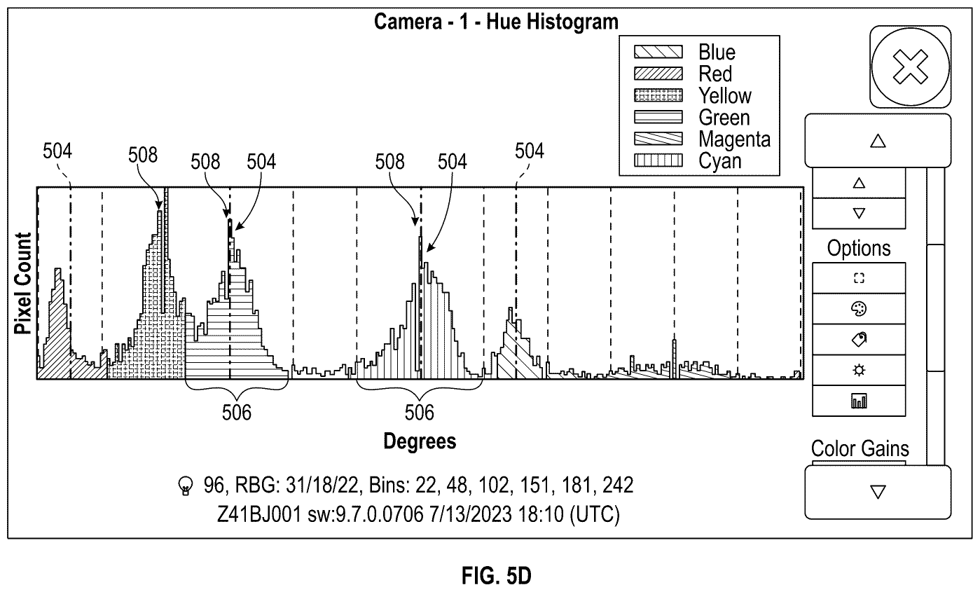

The cameras compare imaging data from a currently scanned image with imaging data from stored reference images and make a presence and absence determination based on current image data similarity to the stored reference data from images where all items are present or where the tool is absent. The stored image data consists of mathematical values for hue, intensity and saturation levels in a silhouette contained within various regions of interest. The automated tool control system evaluates the hue, intensity and saturation data and classifies them for later use. Accordingly, the camera can be used to capture an image of the tool and the associated color-coded tag (identifier) 502 as depicted in FIG. 5A.

For definition purposes, the terms “color” and “hue” are interchangeable in this application. Considerations for inconsistent or incorrect color/hue values being stored can cause the colors/hue to blur or smear resulting in a color/hue mix or blend on the edges of the color/hue “bins.” This results in new and unexpected colors/hues and causes misidentified tags. Discerning between two identical stored items can require periodic recalibration or inspection. Further, when identical tools are present in a single box and are issued to multiple users, the tools may be mixed up when one user returns a tool to a silhouette having an item issued to another user. Some additional causes of misidentification encountered in use of the color-coded striped tags are 1) Tag color hue printing is inconsistent; 2) Hue values captured by different cameras are inconsistent due to mismatches in camera gains/exposure/lighting; 3) Over exposure results in color saturation; 4) Under exposure results in gray color values; and 5) Capturing tag images while the tool storage drawer is in motion can blur or smear adjacent colors together. As depicted in FIG. 5B, the image data captured may yield an image incapable of providing an accurate color distinction. A cause for misidentification is that the cameras themselves detect colors incorrectly. This is a result of incorrect color/hue references being set during the calibration process. Discerning between two identical stored items can require periodic recalibration or inspection.

In this camera based Automated Tool Control System feature, a color striped tag (identifier) 502 is affixed to a tool, the cameras scan the item, evaluate the colors, and assign their values to one of six color “bins” (506), e.g., Red, Yellow, Green, Cyan, Blue and Magenta (Purple). The color bins can be defined by a range of boundary values. An example range of boundary values can comprise a hue value between 45 degrees and 75 degrees, which may be classified as “yellow.” In a further aspect, the total range of boundary values for all of the bins can be consistent with the degrees of a circle (e.g., 360 degrees), thus the x-axis of the histogram in FIG. 5D can span 360 degrees. The y-axis represents a bin count, wherein a count represents the pixel in the ROI; based on the color associated with the pixel, that pixel will be counted and placed in the respective color bin. The maximum intensity value 508 identifies where the most counted pixels of that particular color exist within the boundary values of the color. The centerline 504 defines the hue value at the center of the bin 506. Further, a bin for a color can comprise a gradient of shades as the color traverses between the boundary values of the bin.

When the camera views a region of interest (ROI) and determines there are color-coded tags (e.g. color striped identifier on a tool 502), then the system software determines the tag is a specific code and it associates the tag code with the stored item. During calibration, the cameras can analyze the hue/color data and then the colors are centered on each hue/color “bin.” The user can also adjust the color bins to contain the color/hue data and separate the colors from adjacent colors.

The storage systems 100 or 300 can be configured to also perform tool tag identification, a color calibration, and color recognition adjustment to facilitate managing tool presence. A process 1100 to implement these identification, calibration and adjustment steps can comprise step 1102, wherein image pixels are received from a video sensor such as a camera in a raw Bayer pattern (RGB). In step 1104, pixels within an ROI (region of interest) containing a tool silhouette can be converted from RGB into a numeric hue value. Pixels that are above or below a defined brightness threshold can be rejected as gray/white non-color pixels. In a further aspect, the numeric hue values can be grouped into a range (bin) of boundary values to signify a particular color associated with the color-coded tag on a tool. In step 1106, hue values can be correlated to tag colors based on a predefined range of values associated with each tag color.

In step 1108, the ROI in the captured image can be used to identify a pattern of pixels meeting the criteria for a valid tag pattern. During identification, a search can be repeated for multiple expected tag sizes or valid pattern rules. For example, once a range of hue boundary values have been determined, the processor can determine which sections of the pixelated image are consistent with the various colors of the color-coded tag (identifier) on the tool. In a further aspect of step 1108, counts of valid tag pattern pixels can be accumulated, wherein pattern values and pixel counts can be reported for each detected value. For example, the discrete arrangement of the color-coded tag can be determined, such as for the color-coded tag identifier 502 in FIG. 5A having the pattern of blue, red, yellow, red, yellow, blue, yellow, red, green. In yet a further aspect, step 1108 can comprise a validation of the image date associated with the tag 502, wherein boundary values are applied to determine whether reported value/count data constitutes a valid detected tag. The threshold values can include a minimum reported count based on tag size and a minimum difference between highest reported count value and other reported values. In step 1110, the method can comprise determining the presence or absence of the tool based on a comparison between the captured image data and the stored reference data for the respective tool in the storage container.

In a further aspect, the processor can also be calibrated and/or adjust the RGB gains in the system to correct for inconsistencies with preestablished color reference parameters. In one aspect, the color reference parameters comprise white calibration dot strips. During calibration, the white calibration dot strips can be used as a basis of comparison to the colored pixels of a particular image. In response, the user may more precisely establish color/hue bin limits on the spectrum and segregate the scanned colors/hues into accurate ranges (bins). A program associated with the calibration can allow feedback and adjustment capabilities to customize the color/hue detection and assignment to spectrum-based color/hue bins which provide for optimization of color/hue recognition and correct tag code recognition. The adjustment routine can further define the range of hue values for a particular color. In response, the histogram in FIG. 5D can be used to more accurately determine the colors associated with the image data.

In a further aspect, the RGB adjustments can be made for each camera in a toolbox. As depicted in FIG. 5C, bin limits can be set for all cameras in a toolbox. The associated calibration process can automatically evaluate the colors/hues and automatically set RGB colors, bin bandwidths and bin limits and display them visually on an ATC device screen 503 as depicted in FIG. 5C. Calibration can also be enhanced by a dedicated white calibration band to be permanently mounted in the camera field of view. Additionally, calibration techniques can include making a first reference color visible on a first drawer which is then used as the reference for all other drawers in a box. Further, RGB gains can be adjusted to adjust spacing of hues between expected tag colors. For example, the earlier discussed hue value range for yellow was 45 to 75 degrees, with a maximum intensity (508) at approximately 60 degrees, wherein an adjustment gain for the color yellow may expand the range from 50 to 80 degrees with a maximum intensity at 65 degrees. In other adjustment solutions, the adjustment gain may cause the range of hue values to decrease and decrease the maximum intensity. Other adjustment combinations can comprise of an increase of maximum value intensity.

As depicted in FIG. 5D, a histogram of detected hue values can be used for generating feedback for gain adjustment. Gains are adjusted to make peaks consistent between cameras and maximize spacing between peaks. At the end of calibration, the calibration application can provide a feedback display of live ROI images that can be shown to the user. The display can be configured to switch between: 1) a raw image, 2) an image converted to idealized detected hue values (pure red, yellow, green, etc. pixels based on detected hue of raw pixel), and 3) a histogram showing counts of detected hue values, with each bin count painted in its detected ideal color.

During calibration for a particular color, the calibration protocol can comprise identifying a reference point within the boundary range of hue values. The maximum intensity value 508 (peak) for the respective boundary range 506 and a variance can be determined. Based on the calculation of the variance, the maximum intensity value 508 can be shifted within the boundary range 506. The calibration can also comprise the augmented abilities that include adjusting and saving hue threshold limits to appropriately classify a known tag; establish dead-bands of invalid hue values represented by transition area between colors; and reject invalid tag colors that are the result of blurred pixels between “ideal” middle of tag colors.

In still another implementation, each object stored in the system 300 includes an attached identifier unique (e.g., arrangement of the color-coded tag 502) to each object. The data processor has access to pre-stored information identifying each tool stored in the system and known information identifying a relationship between each object and a respective identifier unique to each pre-designated object. The data processor determines an inventory condition of objects by evaluating identifiers that exist in an image of the storage locations captured by the image sensing device, and the relationship between each pre-designated object and a respective identifier unique to each pre-designated object. For instance, system 300 stores a list of tools stored in the system and their corresponding unique identifiers. After cameras 310 captures an image of a storage drawer, the data processor determines which identifier or identifiers are in the image. By comparing the identifiers appearing in the image with a list of tools and their corresponding unique identifiers, the data processor determines which tools are in the system and which ones are not.

As discussed earlier, identifiers associated with the storage locations may be used to determine which locations have missing objects. According to one implementation, system 300 does not need to know the relationship between each storage location and the corresponding object. Rather, each identifier is unique to a corresponding object stored in the storage location. The data processor of system 300 has access to pre-stored information identifying a relationship between each identifier and the corresponding object, and information identifying each object. In other words, system 300 has access to an inventory list of every object stored in system 300 and its respective unique identifier. When an empty tool storage location is detected by system 300, the corresponding identifier is extracted from the image and decoded by system software. As each identifier is unique to a corresponding object, system 300 is able to determine which object is missing by checking the relationship between each identifier and the corresponding object, and the inventory list of objects. Each identifier unique to an object stored in a storage location may be disposed next to the storage location or in the storage location. In one implementation, the identifier is disposed next to the storage location and is always viewable to the image sensing device no matter whether the location is occupied by an object or not. In another implementation, when an identifier is disposed in the corresponding location, the identifier is not viewable to the image sensing device when the location is occupied by an object, and is viewable to the image sensing device when the location is not occupied by an object.

An implementation of this disclosure utilizes combinations of baseline images and identifiers unique to objects to determine an inventory status. For example, a baseline image may include information of a storage drawer with all storage locations occupied with their respective corresponding objects, wherein each storage location is associated with an identifier unique to an object stored in the storage location. An inventory condition is determined by comparing an image of the storage locations and the baseline image, to determine which locations are occupied by objects and/or which locations have missing objects. Identifications of the missing objects are determined by identifying the identifier associated with each storage location with the missing object.

Another implementation of this disclosure utilizes unique combinations of identifiers to determine an inventory status. For instance, each storage location may have a first type of identifier disposed in the location and a second type of identifier unique to an object stored in the storage location and disposed next to the storage location. The first type of identifier is viewable to an image sensing device when the location is not occupied by an object and not viewable by an image sensing device when the location is occupied by an object. The first type of identifier may be made of retro-reflective material. If a storage location is not occupied by an object corresponding to the storage location, the identifier of the first type is viewable by the image sensing device and shows up as a high intensity area. Accordingly, each high intensity area represents a missing object, which allows system 300 to determine which locations have missing objects. Based on identifiers of the second type associated with those locations with missing objects, system 300 identifies which objects are missing from system 300. Consequently, an inventory condition of system 300 is determined.

According to still another implementation, system 300 uses image recognition methods to identify an object missing from system 300. System 300 has access to an inventory list indicating which tools are stored in each drawer or system 300. However, system 300 does not have to know where the tools are stored. The tools are placed in foam cutout locations specific for each tool. Using characteristics such as size, shape, color, and other parameters, image recognition software identifies each tool in the drawer. Missing tools are simply the tools on the inventory list that are not identified as being in the drawer.

System 300 records access information related to each access. The access information includes time, user information related to the access, duration, user images, images of storage locations, identities of storage units or contents of the storage system, objects in the storage system, etc., or any combinations thereof. In one implementation, system 300 includes a user camera that captures and stores an image of the person accessing storage system 300 each time access is authorized. For each access by a user, system 300 determines an inventory condition and generates a report including associating the determined inventory condition with access information.

### Timed Image Capturing

Implementations of this disclosure utilize uniquely timed machine imaging to capture images of system 300 and determine an inventory condition of system 300 according to the captured images. In one implementation, system 300 activates or times imaging of a storage drawer based on drawer locations and/or movements, in order to create efficient and effective images. For instance, a data processor of the system 300 uses drawer positions to determine when to take overlapping partial images as discussed relative to FIGS. 4A-4E, to assure full coverage of a drawer being accessed by a user. In another example, drawer position information may be useful to the stitching software in the construction of a full drawer image. Drawer position information may be used to help locate the positions of the cutouts in the drawer.

In one implementation, the data processor of system 300 controls the image sensing device to form images of a drawer based on a pre-specified manner of movement by the drawer. For instance, for each access, system 300 only takes images of the drawer when it is moving in a specified manner or in a predetermined direction. According to one implementation, the image sensing device takes images when a drawer is moving in a direction that allows decreasing access to its contents or after the drawer stops moving in the direction allowing decreasing access to its contents. For example, cameras may be controlled to take pictures of drawers when a user is closing a drawer, when or after a drawer stops moving in a closing direction or when the drawer is completely closed. In one implementation, no images are taken when the drawer is moving in a direction allowing increasing access to its contents, such as when a drawer moves from a close position to an open position.

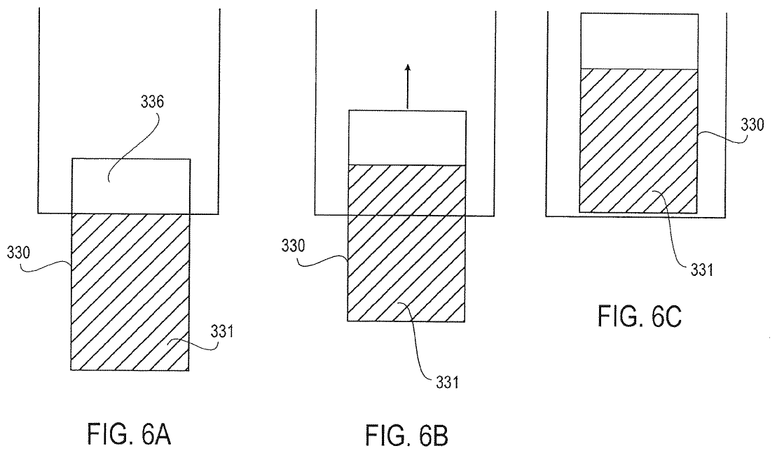

FIGS. 6A-6C show an operation of this implementation in the setting of an exemplary system described in FIGS. 4A-4D. As shown in FIG. 6A, a user partially opens drawer 330 to expose storage locations in shaded area 331. Since the user only opens drawer 330 halfway, the user has no access to storage locations in area 336. After the user finds the tool he needs from area 331, the user starts to close drawer 330 (FIG. 6B). When sensors in system 300 detect the closing movement of drawer 330, which allows decreasing access to contents, the data processor activates the image sensing device, such as cameras 310, to capture partial images of shaded area 331 until drawer 330 is fully closed (FIG. 6C). Since the user never has any access to area 336, it is safe to assume that an inventory condition relative to area 336 remains unchanged from the previous access. However, for area 331, since the user had access to that area, an inventory associated with that area needs to be updated. Any changes in access or replacement of tools would occur only in area 331. Therefore, system 300 determines an inventory condition of drawer 330 associated with the access by the user based on the captured image covering area 331 and inventory information related to area 336 of a previous access, the information of which may be retrieved from a non-volatile memory device of system 300 that stores inventory information associated with each access to system 300. The determined inventory condition for drawer 330 is then stored in the non-volatile memory device. In one implementation, the non-volatile memory device stores an initial inventory condition of drawer 330 which represents a baseline inventory condition with which later inventory conditions may compare. For instance, after each auditing of tool inventory condition, system 300 stores the inventory condition after the audit as the baseline inventory condition.

Locations, movements and moving directions of each storage drawer may be determined by using sensors to measure location or movement sensors relative to time. For instance, location information relative to two points in time may be used to derive a vector indicating a moving direction.

Examples of sensors for detecting a position, movement or moving direction of storage drawers include a sensor or encoder attached to a drawer to detect its position relative to the frame of system 300; a non-contact distance measuring sensor for determining drawer movement relative to some position on the frame of the system 300, such as the back of the system 300; etc. Non-contact sensors may include optical or ultrasonic sensors. A visible scale or indicator viewable by cameras 310 may be included in each drawer, such that camera 310 could read the scale to determine drawer position.

A change in an inventory condition, such as removal of tools, occurring in the current access may be determined by comparing inventory conditions of the current access and the access immediately before the current access. If one or more objects are missing, system 300 may generate a warning signal, such as audible or visual, to the user, generate a notice to a remote server coupled to system 300, etc.

In another implementation, the image sensing device is configured to form images of the storage locations both when storage drawer 330 moves in a direction allowing increasing access to its contents, and when storage drawer 330 subsequently moves in a direction allowing decreasing access to its contents. For example, when a user opens drawer 330 to retrieve tools, the moving direction of drawer 330 triggers cameras 310 to capture images of drawer contents when it moves. The captured image may be designated as a “before access” image representing a status before a user has accessed the contents of each storage drawer. An inventory condition is determined based on the captured images. This inventory condition is considered as a “before access” inventory condition. Cameras 310 stop capturing images when drawer 330 stops moving. When the user closes drawer 330, the moving direction of drawer 330 triggers cameras 310 to capture images of drawers 330 again until it stops or reaches a close position. An inventory condition of the drawer is determined based on images captured when the user closes drawer 330. This determined inventory condition is designated as an “after access” inventory condition. A difference between the before access inventory condition and the after access inventory condition indicates a removal or replacement of tools. Other implementations of this disclosure control cameras to take the “before access” image before a storage drawer is opened or after the storage drawer is fully opened or when its contents are accessible to a user. According to another implementation, the image sensing device is timed to take an image of each drawer 330 when it was detected that access by a user is terminated. As used herein in this disclosure, terminated access is defined as a user no longer having access to any storage locations, such as when drawer 330 is closed or locked, when door 250 is closed or locked, etc., or an indication by the user or the system that access to the storage system is no longer desired, such as when a user signs off, when a predetermined period of time has elapsed after inactivity, when a locking device is locked by a user or by system 300, etc. For each access, a position detector or contact sensor is used to determine whether drawer 330 is closed. After the drawer is closed, the image sensing device captures an image of drawer 330. The data processing system then determines an inventory condition based on the captured image or images. A difference in the inventory condition may be determined by comparing the determined inventory condition of the current access to that of the previous access.

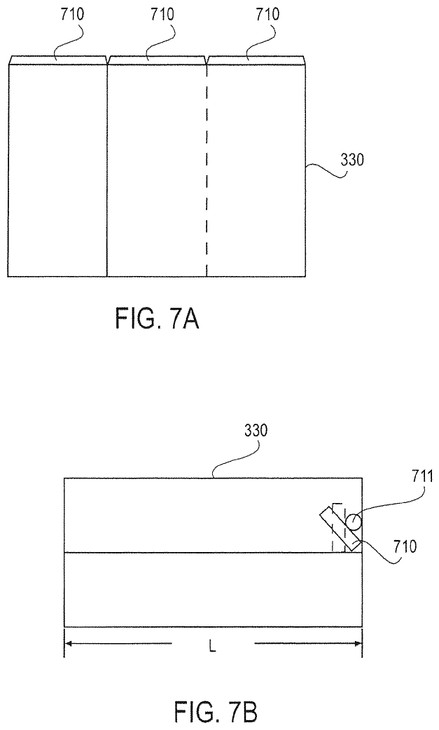

FIGS. 7A and 7B show an exemplary drawer having cameras configured to capture images of the drawer when it is closed. FIG. 7A is a top view of a drawer 330 having three cameras 710. Cameras 710 have sufficient widths of viewing fields to cover the entire width of drawer 330. FIG. 7B is a side view of drawer 330 shown in FIG. 7A. Camera 710 tilts down a specific angle and has a sufficiently large viewing field to cover the entire length L of drawer 330. In one implementation, cameras 710 do not have to cover the entire length L with one image. Rather, camera 710 may be rotatably attached to a hinge 711, which allows the camera to tilt up and down vertically, to cover different sections of drawer 330. Images captured by cameras 710 are stitched or combined to form an image of the entire drawer.

It is understood that other camera configurations or designs may be utilized to capture images of drawer 330 when it is closed. In one implementation, one or more moving cameras are used to capture images of a drawer after it is closed. In this implementation, the cameras are configured to move over the drawer and capture image slices that can be stitched together to create a full drawer image. The cameras may be moved by a motor along a rail. Either 2D or line scan cameras can be used in this model. A sensor may be used to determine the location of the cameras to assist in stitching or other functions such as camera position control. A variation of this model uses a stationary camera for each drawer viewing across the top of the drawer and a 45-degree moving mirror that moves over the drawer and redirects the camera view towards the drawer. Another variation is to provide a camera moving from one drawer to another. Still another variation is to provide a moving mirror for each drawer and one or more cameras moving between drawers. The movements of the cameras and mirrors are synchronized to form images of each storage drawer. The cameras and drawers may be driven by motors or any means that provide power.

If the image sensing device requires illumination to obtain acceptable image quality, illumination devices may be provided. For example, LEDs may be used to illuminate the image area. It is understood that other illumination sources may be used. In one implementation, LEDs are disposed surrounding the lens or image sensors of the camera and light is transmitted along the same path as the camera view. In an implementation including the use of a light directing device, such as a mirror, the emitted light would be directed by the mirror towards the drawers. The timing and intensity of the illumination is controlled by the same processor that controls the camera and its exposure. In some possible configurations of cameras, it may be desirable to implement background subtraction to enhance the image. Background subtraction is a well-known image processing technique used to remove undesirable static elements from an image. First an image is captured with illumination off. Then a second image is captured with illumination on. The final image is created by subtracting the illumination off image from the illumination on image. Image elements that are not significantly enhanced by the illumination are thereby removed from the resulting image.

According to another implementation, for each access, the image sensing system 300 is timed to capture at least two images of drawer 330: at least one image (initial image) captured before a user has access to storage locations in drawer 330 and at least one image captured after the access is terminated, as discussed earlier. The initial image may be taken at any time before the user has access to the contents or storage locations in the drawer. In one implementation, the initial image is captured when or after a user requests access to system 300, such as by sliding a keycard, punching in a password, inserting a key into a lock, providing authentication information, etc. In another implementation, the initial image is captured before or in response to a detection of drawer movement from a close position or the unlock of a locking device of system 300.

The data processing system of system 300 determines an inventory condition based on the initial image, and assigns the determined inventory condition as “before access” inventory condition; and determines an inventory condition based on the image captured after the access is terminated and designates the determined inventory condition as “after access” inventory condition. A change in the inventory condition of objects in system 300 may be determined based on a comparison of the “before access” and “after access” inventory conditions or a comparison of the initial image and the image captured after the access is terminated.

Concepts and designs described above may be applicable to other types of storage systems, such as a type shown in FIG. 1B, where a single door controls the access to multiple shelves or drawers. In one implementation, the image sensing device may be timed to capture images of the storage locations when or after a detected termination of access, such as closing door 250, locking door 250, signing out, etc. It is understood that various types of sensors, such as contact sensors and infrared sensors, may be used to determine when a door is closed. Similar to the discussions earlier, the image sensing device captures images of the storage locations, and determines an “after access” inventory condition based on the captured image. A change in the inventory condition is related to the access by comparing an inventory condition of the current access and that of the last access. According to another implementation, the image sensing device is timed to take “before access” images of the storage locations before a user has access to the storage system. For instance, the cameras may be timed to capture images of the storage locations when or after a user requests access to the system, after detecting an opening of door 250, after receiving authentication information from a user, etc. The storage system determines a “before access” inventory condition based on the “before access” image. A change in the inventory condition may be determined according to a difference between the “before access” and “after access” inventory conditions, or a difference between the “before access” and “after access” images.

### Networked Storage Systems

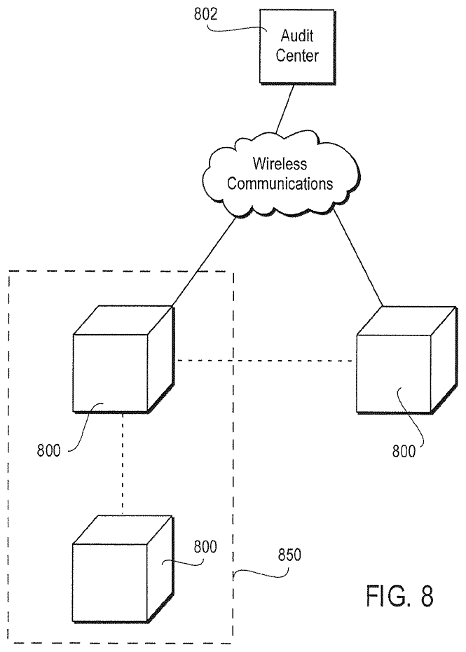

Storage systems described in this disclosure may be linked to a remote server in an audit center, such that inventory conditions in each storage system are timely updated and reported to the server. As shown in FIG. 8, a server 802 is coupled to multiple storage systems 800 via a wireless network. Server 802 may include a database server, such as a Microsoft SQL server. Information related to authentication, authorized users, inventory conditions, audit trails, etc., is stored in the database.

In one implementation, each storage system 800 is provided with a data transceiver, such as an 802.11g or Ethernet module. The Ethernet module connects directly to the network, while a 802.11g module may connect through a 802.11g router connected to the network. Each of these network modules will be assigned a static or dynamic IP address. In one implementation, storage systems 800 check in to the server through the data transceivers on a periodic basis, to download information about authorized users, the authorization levels of different users or different keycards, related storage systems, etc. Storage systems 800 also upload information related to the systems, such as inventory conditions, drawer images, tool usage, access records, information of users accessing storage systems 800, etc., to server 802. Each storage system 800 may be powered by an AC source or by a battery pack. An uninterruptible power supply (UPS) system may be provided to supply power during a power failure.

Server 802 allows a manager or auditor to review access information related to each storage system 800, such as inventory conditions and information related to each access to storage system 800 like user information, usage duration, inventory conditions, changes in inventory conditions, images of drawers or contents of the storage system, etc. In one implementation, server 802 may form a real-time connection with a storage system 800 and download information from that storage system. The manager or auditor may also program the access control device on each storage system through server 802, such as changing passwords, authorized personnel, adding or deleting authorized users for each storage system, etc. Authorization data needed for granting access to each storage system 800 may be programmed and updated by server 802 and downloaded to each storage system 800. Authorization data may include passwords, authorized personnel, adding or deleting authorized users for each storage system, user validation or authentication algorithms, public keys for encryptions and/or decryptions, a black list of users, a white list of users, etc. Other data updates may be transmitted to each storage system from server 802, such as software updates, etc. Similarly, any changes performed on storage system 800, such as changing passwords, adding or deleting authorized users, etc., will be updated on server 802.

For each access request submitted by a user, a storage system authenticates or validates the user by determining a user authorization according to user information input by the user via the data input device and the authorization data. According to the result of the authentication, the data processor selectively grants access to the storage system by controlling an access control device, such as a lock, to grant access to the storage system 800 or one or more storage drawers of one or more storage systems 800.

Server 802 also allows a manager to program multiple storage systems 800 within a designated group 850 at the same time. The manager may select which specific storage systems should be in group 850. Once a user is authorized access to group 850, the user has access to all storage systems within group 850. For instance, a group of storage systems storing tools for performing automotive service may be designated as an automotive tool group, while another group of storage systems storing tools for performing electrical work may be designated as an electrical tool group. Any settings, adjustments or programming made by Server 802 in connection with a group automatically apply to all tool storage systems in that group. For instance, server 802 may program the tool storage systems by allowing an automotive technician to access all tool storage systems in the automotive tool group, but not those in the electrical tool group. In one implementation, each system 800 only includes minimal intelligence sufficient for operation. All other data processing, user authentication, image processing, etc., are performed by server 802.

Similarly, server 802 also allows a manager to program multiple storage drawers 330 within a designated group at the same time. The manager may select which specific storage drawers of the same system or different storage systems should be in the group. Once a user is authorized access to the group, the user has access to all storage drawers within the group. For instance, a group of storage systems storing tools for performing automotive tools may be designated as an automotive tool group, while another group of storage systems storing tools for performing electrical work may be designated as an electrical tool group.

In another implementation, an exemplary networked storage system as shown in FIG. 8 utilizes hierarchical authorization architecture to manage access to storage systems. One or more storage systems 800 are given the status of master storage system. Each master storage system has one or more associated slave storage systems. If a user is authorized to access a master storage system, the same user is automatically authorized to access any slave storage system associated with that master system. On the other hand, if a user is authorized to access a slave storage system, the authorization to the slave system does not automatically grant the user access to its associated master storage system or other slave storage systems associated with the same master storage system.

According to still another implementation, an exemplary networked storage system as shown in FIG. 8 grants user access by utilizing multiple hierarchical authorization levels. Each authorization level is associated with pre-specified storage systems, which can be programmed by a manager via server 802. When a user is assigned a specific authorization level, this user is authorized to access all storage systems associated with the assigned authorization level and all storage systems associated with all authorization levels lower than the assigned authorization level in the authorization hierarchy, but not to those associated with authorization levels higher than the assigned authorization level in the authorization hierarchy.

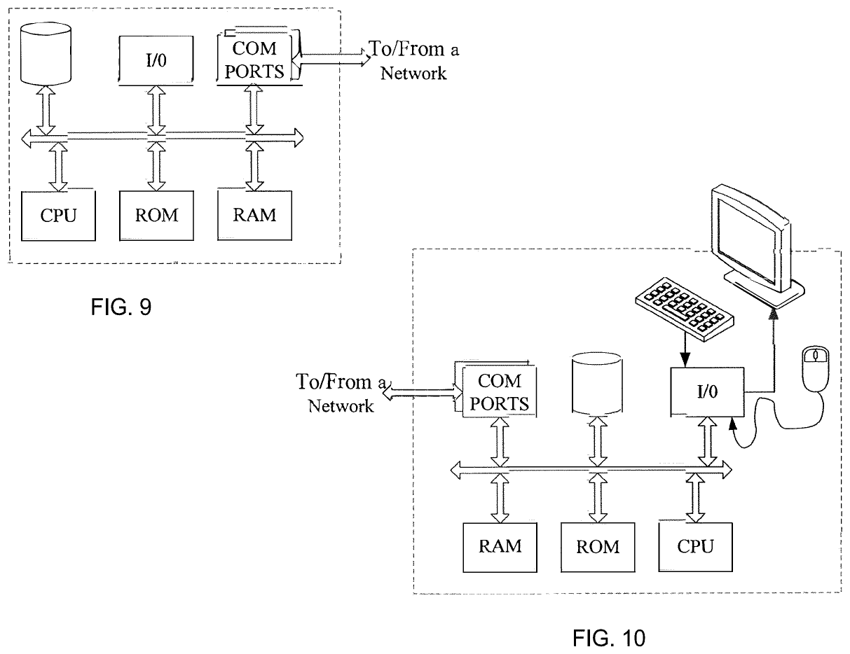

FIGS. 9 and 10 provide functional block diagram illustrations of general-purpose computer hardware platforms. FIG. 9 illustrates a network or host computer platform, as may typically be used to implement a server. FIG. 10 depicts a computer with user interface elements, which may be used to implement a personal computer or other type of work-station or terminal device, although the computer of FIG. 10 may also act as a server if appropriately programmed. It is believed that the general structure and general operation of such equipment, as shown in FIGS. 9 and 10, should be self-explanatory from the high-level illustrations. A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

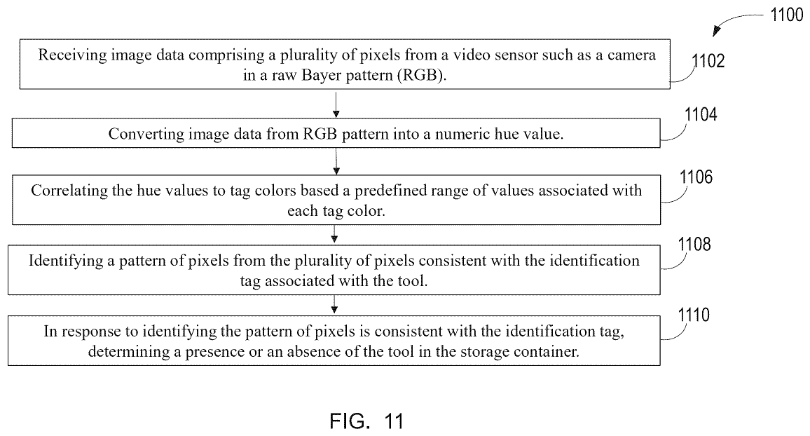

A computer-type user terminal device (e.g., the inventory control system) similarly includes a data communication interface CPU, main memory and one or more mass storage devices for storing user data and the various executable programs (see FIG. 11). The various types of inventory control systems will also include various user input and output elements. For example, the inventory control system may include a keyboard and a cursor control/selection device such as a mouse, trackball, joystick or touchpad; and a display for visual outputs. A microphone and speaker enable audio input and output. Some other inventory control systems include similar but smaller input and output elements. The inventory control system may utilize touch sensitive display screens instead of separate keyboard and cursor control elements. The hardware elements, operating systems and programming languages of such user terminal devices are also conventional in nature.

Hence, aspects of the methods of monitoring the removal and replacement of tools within an inventory control system outlined above may be embodied in programming. Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may, at times, be communicated through the Internet or various other telecommunication networks. Such communications, for example, may enable the loading of the software from one computer or processor into another, for example, from the server 802, to the inventory control system. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the monitoring, removal, and replacement of tools within an inventory control system, etc., shown in the drawings. Volatile storage media include dynamic memory, such as the main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer-readable media may be involved in carrying one or more sequences of one or more instructions to a processor for execution.

While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study, except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method for tool identifier recognition and sensor calibration in a tool control system, the method comprising:
capturing image data comprising a plurality of pixels of an identification tag associated with a tool in a storage container;
correlating the plurality of pixels to a numeric hue value;
determining a boundary range for a color to differentiate a plurality of colors from each other, wherein the boundary range comprises a range of numeric hue values;
identifying a pattern of pixels from the plurality of pixels, wherein the pattern of pixels is correlated to a known pattern of color parameters consistent with the identification tag associated with the tool in the storage container; and
in response to identifying the pattern of pixels is consistent with the identification tag, determining a presence or an absence of the tool in the storage container.

2. The method of claim 1, further comprising adjusting a maximum value of the boundary range which comprises:
identifying at least one reference point within the boundary range, wherein the at least one reference point comprises at least one hue value;
determining a variance between the maximum value of the boundary range to the variance with the at least one hue of the reference point; and
in response to the determining the variance, adjusting the maximum value for the boundary range by increasing or decreasing the maximum value.

3. The method of claim 1, further comprising implementing a color gain to adjust a boundary range.

4. The method of claim 3, further comprising updating an inventory status of the tool.

5. The method of claim 1, wherein the captured image data is from a camera and formatted in a raw Bayer pattern (RGB), wherein the image data comprises a (region of interest) containing a tool silhouette.

6. The method of claim 1, wherein the boundary ranges comprise a range of numeric hue values, where a numeric hue value is associated with a pixel of the plurality of pixels.

7. The method of claim 1, wherein the pixel comprising the numeric hue value is outside a range of a predefined threshold and is defined as a gray/white non-color pixel.

8. The method of claim 1, further comprising generating an image associated with the identification tag.

9. An inventory control system for tool identifier recognition and sensor calibration in a tool control system, comprising:
a plurality of storage containers, where each storage container comprises:
a plurality of storage locations for storing objects;
at least one image sensing device configured to capture image data of the plurality of storage locations; and
a data processor configured to execute machine readable instructions to:
capture image data comprising a plurality of pixels of an identification tag associated with a tool in a storage container;
correlating a plurality of pixels to a numeric hue value;
identifying a pattern of pixels from the plurality of pixels, wherein the pattern of pixels is correlated to a known pattern of color parameters consistent with the identification tag associated with the tool in the storage container; and
in response to identifying the pattern of pixels is consistent with the identification tag, determining a presence or an absence of the tool in the storage container.

10. The system of claim 9, wherein the instructions are further configured to:
adjust a maximum value of a boundary range which comprises:
identify at least one reference point within the boundary range, wherein the at least one reference point comprises at least one hue value;
determine a variance between the maximum value of the boundary range to the variance with the at least one hue of the reference point; and
in response to the determining the variance, adjusting the maximum value for the boundary range by increasing or decreasing the maximum value.

11. The system of claim 9, wherein the instructions are further configured to implement a color gain to adjust the boundary range.

12. The system of claim 9, wherein the captured image data is from a camera and formatted in a raw Bayer pattern (RGB), wherein the image data comprises a (region of interest) containing a tool silhouette.

13. The system of claim 9, wherein the pixel comprising the numeric hue value is outside a range of a predefined threshold and is defined as a gray/white non-color pixel.

14. The system of claim 9, wherein the instructions are further configured to: further comprise generating an image associated with the identification tag.

15. A non-transient computer-readable storage medium having instructions embodied thereon, the instructions being executable by one or more processors to perform a method for tool identifier recognition and sensor calibration in a tool control system, the method comprising:
capturing image data comprising a plurality of pixels of an identification tag associated with a tool in a storage container;
correlating a plurality of pixels to a numeric hue value;
identifying a pattern of pixels from the plurality of pixels, wherein the pattern of pixels is correlated to a known pattern of color parameters consistent with the identification tag associated with the tool in the storage container;
in response to identifying the pattern of pixels is consistent with the identification tag, determining a presence or an absence of the tool in the storage container; and
implementing a color gain to adjust a boundary range for a color.

16. The non-transient computer-readable storage medium of claim 15, further comprising:
adjusting a maximum value of the boundary range which comprises:
identifying at least one reference point within the boundary range, wherein the at least one reference point comprises at least one hue value;
determining a variance between the maximum value of the boundary range to the variance with the at least one hue of the reference point; and
in response to the determining the variance, adjusting the maximum value for the boundary range by increasing or decreasing the maximum value.

17. The non-transient computer-readable storage medium of claim 15, wherein the boundary ranges comprise a range of numeric hue values, where a numeric hue value is associated with a pixel of the plurality of pixels.

18. The non-transient computer-readable storage medium of claim 15, wherein the pixel comprising the numeric hue value is outside a range of a predefined threshold and is defined as a gray/white non-color pixel.

19. The non-transient computer-readable storage medium of claim 15, further comprising generating an image associated with the identification tag.

20. The non-transient computer-readable storage medium of claim 15, further comprising updating an inventory status of the tool.
